(19) United States
(12) Patent Application Publication
(10) Pub. No.: US 2019/0350206 A1
(43) Pub. Date: Nov. 21, 2019

(54) Herbicide composition for use in killing one or more plant species

(71) Applicant: Agro Research International, LLC, Sorrento, FL (US)

(72) Inventor: Marc Lajeunesse, Sorrento, FL (US)

(21) Appl. No.: 16/415,582

(22) Filed: May 17, 2019

Related U.S. Application Data
(60) Provisional application No. 62/672,843, filed on May 17, 2018.

(51) Int. Cl. A01N 63/00; A01N 31/14; A01N 33/08; A01N 25/14

(52) U.S. Cl. CPC A01N 63/00; A01N 31/14; A01N 25/30; A01N 25/14; A01N 33/08

(57) ABSTRACT

An herbicide composition, and method of use of the herbicide composition, for the prevention or minimization of growth and development of a plant species. The herbicide composition is a broad spectrum, non-selective, systemic herbicide.

### CROSS REFERENCE

In accordance with 37 C.F.R. 1.76, a claim of priority is included in an Application Data Sheet filed concurrently herewith. Accordingly, the present invention claims priority to U.S. Provisional Application No. 62/672,843, entitled “HERBICIDE COMPOSITION FOR USE IN KILLING ONE OR MORE PLANT SPECIES”, filed May 17, 2018. The contents of the above referenced application are incorporated herein by reference in its entirety.

### FIELD OF THE INVENTION

The present invention relates to a composition for preventing or minimizing plant growth; to a composition and method of using the composition containing one or more bacteria strains and an essential oil/sugar mixture for preventing or minimizing plant growth; and more particularly, to a composition, and method of using the composition, containing bacterial strains of Streptomyces, Pseudomonas, and Bacillus, and an active ingredient/sugar based mixture for preventing or minimizing growth of various plant species.

### BACKGROUND OF THE INVENTION

Agriculture is vital for enhancing human life. The abilities to provide and obtain food are essential human requirements. The production of grains, fruits and vegetables is critical, both as an economic component and as a human sustainability component. Since the dawn of the human experience, finding ways to enhance crop production has been essential for survival and advancement of the human species. Herbicides, typically chemicals designed to kill plants, have been used by farmers as a strategy to increase crop production. By applying herbicides to the crops, weeds are killed. Without the use of herbicides or other means of killing off weeds, weeds compete for water, sunlight and nutrients. Using herbicides eliminates such competition, and often results in increased crop production. In addition, not having to remove the weeds by hand reduces the economic costs associated with planting, maintaining, and producing crops.

In addition to the need for efficient and cost effective crop production, many societies see value in well-kept and beautifully manicured landscaping. Whether it is a commercial facility trying to maintain a beautiful appearance to attract customers, a residential house desiring a green oasis front or back yard, or a golf course in need of maintaining a fairway and green at each of its course holes, or other sporting venues, such as a baseball field, a football field, or grass tennis courts, herbicides play an important role in maintaining these environments in the manner desired. Without application of an herbicide, these environments would be overcome by weeds, making them less usable and less aesthetically pleasing.

Therefore, what is needed is an herbicide that is effective at killing or preventing plant growth or germination.

### SUMMARY OF THE INVENTION

The present invention provides an herbicide composition, and method of using the herbicide composition, for the prevention or minimization of plant growth. The composition for preventing or minimizing plant growth of the present invention uses a two-component system. The first component includes at least three independent species of bacteria, preferably Streptomyces, Pseudomonas, and Bacillus. The second component includes an essential oil, such as a clove oil or Eugenol, and a bacteria growth source, including a sugar, such as molasses.

As used herein, the term “weed” is used to define or describe a plant species that is considered undesirable, unattractive, or troublesome; especially a plant species that grows where it is not wanted or grows or spreads too fast, or takes the place of desired plant species; a plant species considered undesirable in a particular situation, i.e. a plant species in the wrong place.

In an illustrative embodiment, a composition for the prevention or minimization of growth and development of one or more plant species comprises a plurality of microbial species for preventing or minimizing growth of said one or more plant species; and a microbial species growth or replication enhancer. The microbial species may be a bacterial strain of Streptomyces, Bacillus, Pseudomonas, or combinations thereof. The microbial species growth or replication enhancer may include a sugar, such as molasses, and an essential oil, such as Eugenol.

In another embodiment of the invention, a composition for application to one or more plant species comprises: at least three bacteria species for preventing or minimizing growth of said one or more plant species, wherein at least one bacteria species produces a biosurfactant, and a bacterial species growth or replication enhancer. The composition may be formulated as a two-part component, wherein the at least three bacteria species are separated from the bacterial species growth or replication enhancer. The at least three bacteria species include Streptomyces, Bacillus, and Pseudomonas. The bacterial species growth or replication enhancer may include a sugar, such as molasses, and an essential oil, such as Eugenol.

In another embodiment of the invention, a method of preventing or minimizing growth and development of one or more plant species comprises: applying an effective amount of a composition to a plant or plant component to minimize or prevent plant growth and development of one or more plant species, the composition comprising a plurality of microbial species for preventing or minimizing growth of the one or more plant species; and a microbial species growth or replication enhancer. The microbial species may be a bacterial strain of Streptomyces, Bacillus, Pseudomonas, or combinations thereof. The microbial species growth or replication enhancer may include a sugar, such as molasses, and an essential oil, such as Eugenol.

Accordingly, it is an objective of the invention to provide a two-part composition for preventing or minimizing growth of various plant species.

It is a further objective of the invention to provide a method of preventing or minimizing growth of various plant species.

It is yet another objective of the invention to provide a two-part composition for preventing or minimizing growth of weeds.

It is a still further objective of the invention to provide a method of preventing or minimizing growth of weeds.

It is a further objective of the invention to provide a two-part composition for application to one or more plant species, in which one component comprises an active ingredient for preventing or minimizing growth of the one or more plant species and bacteria growth or replication enhancer.

It is a further objective of the invention to provide a two-part composition for application to one or more plant species, in which one component comprises two or more different bacteria species.

It is a still further objective of the invention to provide a two-part composition for application to one or more plant species, in which one component comprises an active ingredient for preventing or minimizing growth of the one or more plant species and bacteria growth or replication enhancer, and a second component comprises two or more different bacteria species.

It is a further objective of the invention to provide a two-part composition for preventing or minimizing growth of various plant species, in which one part provides at least one bio-surfactant.

It is yet another objective of the invention to provide a broad spectrum two-part herbicide composition for preventing or minimizing growth of various plant species.

It is yet another objective of the invention to provide a non-selective two-part herbicide composition for preventing or minimizing growth of various plant species.

It is yet another objective of the invention to provide a systemic two-part herbicide composition for preventing or minimizing growth of various plant species.

It is yet another objective of the invention to provide a broad spectrum, non-selective, systemic two-part herbicide composition for preventing or minimizing growth of various plant species.

Other objectives and advantages of this invention will become apparent from the following description taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE FIGURES

The patent or application contains at least one drawing executed in color. Copies of this patent or patent application publication with color drawings will be provided by the Office upon request and payment of the necessary fee.

FIG. 1 illustrates Chickweed prior to application of the herbicide;

FIG. 2 illustrates the plant species shown in FIG. 1 after application of the herbicide composition;

FIG. 3 illustrates a plant species prior to application of the herbicide;

FIG. 4 illustrates the plant species shown in FIG. 3 after application of the herbicide composition;

FIG. 5A illustrates Nutsedge two weeks after application of the herbicide composition;

FIG. 5B illustrates Purslane two weeks after application of the herbicide composition; and

FIG. 5C illustrates Crabgrass two weeks after application of the herbicide composition.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

The present invention provides an herbicide composition, and method of use of the herbicide composition, for the prevention or minimization of growth and development of a plant species. The composition of the present invention uses two separate and mixable components to prevent or minimize growth or development of a plant species. The first component comprises at least one active ingredient for preventing or minimizing growth of the one or more plant species and a bacteria growth or replication enhancer. In a preferred embodiment, the first component comprises a mixture of Eugenol, or clove oil, and a sugar, preferably molasses. In a preferred embodiment, the second component comprises two or more different bacteria species, preferably Streptomyces, more preferably, Streptomyces rimosus, Bacillus, more preferably, Bacillus megaterium, and Pseudomonas, more preferably Pseudomonas aeruginosa.

The composition contains at least one microbial strain that provides biosurfactants, which, in combination with the active ingredient that is preventing or minimizing growth of the one or more plant species, provides a mechanism for acting on the plant species internally. Preferably, the active ingredient that is preventing or minimizing growth of the one or more plant species is an essential oil. Accordingly, the herbicide composition is a broad spectrum, non-selective, systemic herbicide. The composition is preferably delivered as a combination pack, including Eugenol and molasses (Pack A) and multiple bacteria strains (Pack B), preferably with at least one bacteria strain which provides biosurfactants that aid in transporting the Eugenol, internally, throughout the plant, and to the root system. As such action provides not just burn out of the above ground portion of the plant species, but also the root system, the composition provides for total death of the plant species. In addition, because the active ingredient is a natural oil, soil sample residuality was observed for several months with no soil toxicity issues detected. The molasses in Pack A is used as a food source, being used by the bacteria for growth and multiplication.

Either of the two-part components of the herbicide composition can be prepared in a liquid form. Alternatively, either of the two-part components of the herbicide composition can be prepared in a soluble, dry powder form. When combined together, i.e. part A and part B, the herbicide composition may be applied to any portion of a plant, and be taken up internally and delivered systemically, preferably to the root system.

Microbial Species: The herbicide composition may include two or more microbial strains or species, or a combination of strains or species.

Bacillus. Bacillus is a Gram-positive, rod shaped bacteria from the phylum Fimicutes. Bacillus is found in soil and water, and is generally an aerobic bacteria, but under certain conditions can be anaerobic. The preferred Bacillus species is an isolated or purified Bacillus megaterium.

Streptomyces. Streptomyces is Gram-positive, filamentous bacteria from the family Streptomycetaceae. Streptomyces is found mostly in soil and decaying vegetables, and is an aerobic bacteria. The preferred Streptomyces species is an isolated or purified Streptomyces rimosus.

Pseudomonas. Pseudomonas is a Gram-negative, rod shaped bacteria from the family Pseudomonadaceae. The preferred Pseudomonas species is an isolated or purified Pseudomonas aeruginosa.

Eugenol: Eugenol is a phenylpropene which can be extracted from essential oils, such as clove oil. It has a preferred IUPAC name of 2-Methoxy-4-(prop-2-en-1-yl)phenol. It has a chemical formula of:

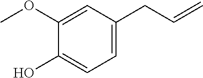

The herbicide is expected to be, or has been shown to be effective at killing or preventing growth to a wide spectrum of plant species, such as but not limited to: grasses and weeds, such as quackgrass, purslane, crabgrass, thistle, nutsedge, sow thistle, dandelion, groundsel, deadnettle, wild geranium, bittercress, chickweed, dock, prickly lettuce, wild vetch, bindweed, common mallow, lambsquarter, and white Dutch clover.

TABLE 1
Example 1. Composition for killing or preventing/minimizing
growth of plant species.

| Component | Concentration |
|---|---|
| A1: Active ingredient for killing | A1: 1%-99% |
| or preventing/minimizing growth | |
| of plant species | |
| A2: Microbial growth source | A2: 1%-99% |
| B1: Microbial Strain 1: uptake | B1/B2: Sufficient to |
| active ingredient into plant | maintain overall activity |
| B2: Microbial species 2: | of the composition for |
| B3: Microbail species 3 | a predetermined time. |

TABLE 2
Example 2. Composition for killing or preventing/minimizing
growth of plant species.

| Component | Concentration |
|---|---|
| Essential Oil Extract | A1: 1%-99% |
| Sugar based microbial | Sufficient concentration to maintain growth |
| growth source | or reproduction of microbial strains for a |
| | predetermined time period |
| Microbial Strain 1: | Cell density of 5.0 × 10³ CFU/ml, or greater |
| uptake essential oil | |
| into plant | |
| Microbial Species 2 | Cell density of 5.0 × 10³ CFU/ml, or greater |
| Microbial Species 3 | Cell density of 5.0 × 10³ CFU/ml, or greater |

TABLE 3
Example 3. Composition for killing or preventing/minimizing
growth of plant species.

| Component | Concentration |
|---|---|
| Essential Oil Extract | 1%-99% |
| Sugar based microbial growth source | Sufficient concentration |
| | to maintain growth or |
| | reproduction of microbial |
| | strains for a predetermined |
| | time period |
| Microbial Component 1: Bacillus | Cell density of 5.0 × |
| | 10³ CFU/ml, or greater |
| Microbial Component 2: Streptomyces | Cell density of 5.0 × |
| | 10³ CFU/ml, or greater |
| Microbial Component 3: Pseudomonas | Cell density of 5.0 × |
| | 10³ CFU/ml, or greater |

TABLE 4
Example 4. Composition for killing or preventing/minimizing
growth of plant species.

| | |
|---|---|
| Essential Oil Extract from Clove | 1%-99% |
| Molasses | Sufficient concentration |
| | to maintain growth or |
| | reproduction of microbial |
| | strains for a predetermined |
| | time period |
| Microbial Component 1: Bacillus | Cell density of 5.0 × |
| | 10³ CFU/ml, or greater |
| Microbial Component 2: Streptomyces | Cell density of 5.0 × |
| | 10³ CFU/ml, or greater |
| Microbial Component 3: Pseudomonas | Cell density of 5.0 × |
| | 10³ CFU/ml, or greater |

TABLE 5
Example 5. Composition for killing or preventing/minimizing
growth of plant species.

| | |
|---|---|
| Eugenol | 1%-99% |
| Molasses | Sufficient concentration |
| | to maintain growth or |
| | reproduction of microbial |
| | strains for a predetermined |
| | time period |
| Microbial Component 1: Bacillus | Cell density of 5.0 × |
| | 10³ CFU/ml, or greater |
| Microbial Component 2: Streptomyces | Cell density of 5.0 × |
| | 10³ CFU/ml, or greater |
| Microbial Component 3: Pseudomonas | Cell density of 5.0 × |
| | 10³ CFU/ml, or greater |

TABLE 6
Example 6. Composition for killing or preventing/minimizing
growth of plant species.

| | |
|---|---|
| Eugenol | 1-10% |
| Molasses and Water | ***90-99.9% |
| Microbial Component 1: Bacillus | Cell density of 5.0 × |
| | 10³ CFU/ml, or greater |
| Microbial Component 2: Streptomyces | Cell density of 5.0 × |
| | 10³ CFU/ml, or greater |
| Microbial Component 3: Pseudomonas | Cell density of 5.0 × |
| | 10³ CFU/ml, or greater |

TABLE 7
Example 7. Composition for killing or preventing/minimizing
growth of plant species

| | |
|---|---|
| Eugenol | 6% |
| Molasses and Water | ***94% |
| Bacillus megaterium | Cell density of 5.0 × |
| | 10³ CFU/ml, or greater |
| Streptomyces rimosus | Cell density of 5.0 × |
| | 10³ CFU/ml, or greater |
| Pseudomonas aeruginosa | Cell density of 5.0 × |
| | 10³ CFU/ml, or greater |

TABLE 8
Example 8. Composition for killing or preventing/minimizing
growth of plant species.

| | |
|---|---|
| Eugenol | 6% |
| Molasses and Water | ***94% |
| Bacillus megaterium | Cell density of 5.0 × |
| | 10³ CFU/ml, or greater |
| Streptomyces rimosus | Cell density of 5.0 × |
| | 10³ CFU/ml, or greater |
| Pseudomonas aeruginosa | Cell density of 5.0 × |
| | 10³ CFU/ml, or greater |

(***): The amount of molasses used is preferably of a sufficient concentration for growth or reproduction of one or all microbial strains for a predetermined time period. The time period may be 48 hours to at least 100 hours, more preferably 60-100 hours, even more preferably 72 hours, and most preferably at least 100 hours, so that the microbial species survive five days to at least ten days. This amount of molasses is then combined with the Eugenol, with the percentages listed relative to the total concentration of component A.

Initial Preparation and Spraying of herbicide composition to plant species: Inoculum of bacterial species, preferably Bacillus megaterium, Streptomyces rimosus, and Pseudomonas aeruginosa was prepared having a cell density of 5.0×10³ CFU/ml, or greater, thus forming component B. Component A, as described in Example 1-8, preferably comprises a mixture of Eugenol (6%) and a molasses/water mixture (94%). Components A and B are then mixed together and applied to the plant species. As an illustrative example, 1 quart per acre into 25, and up to 30, gallons of water per acre was used.

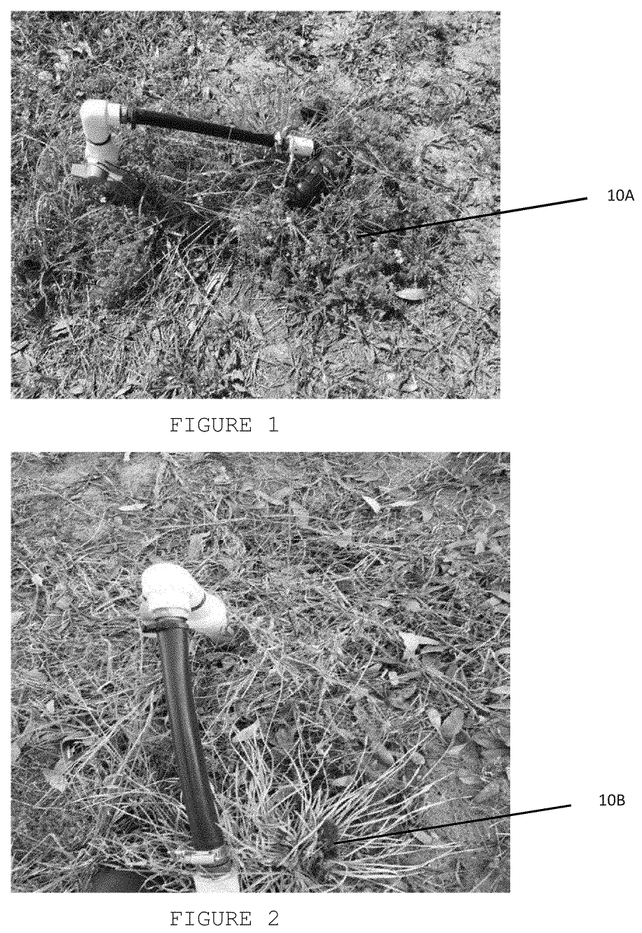

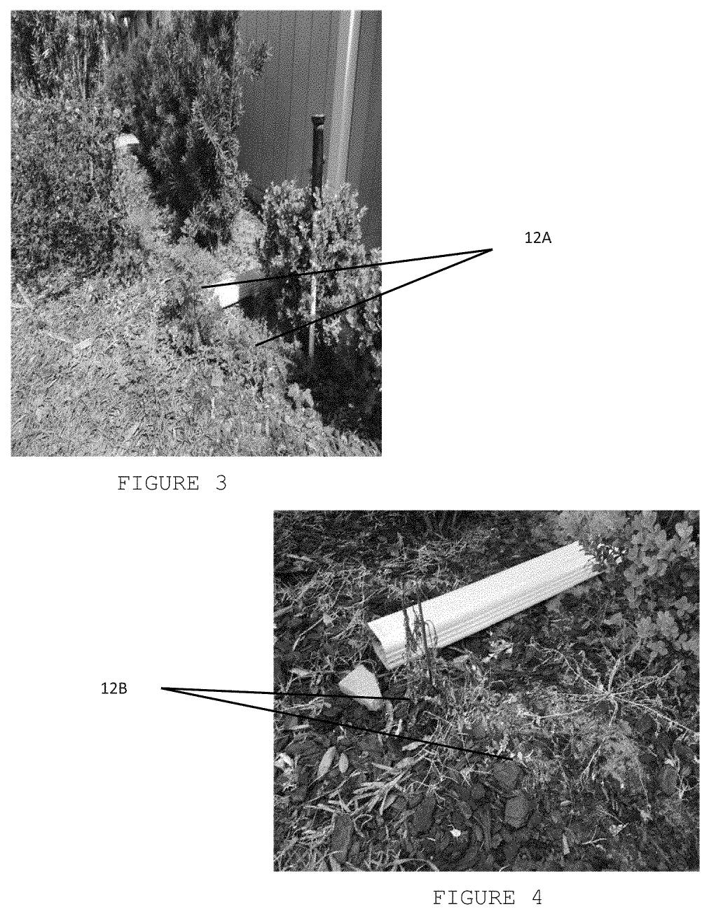

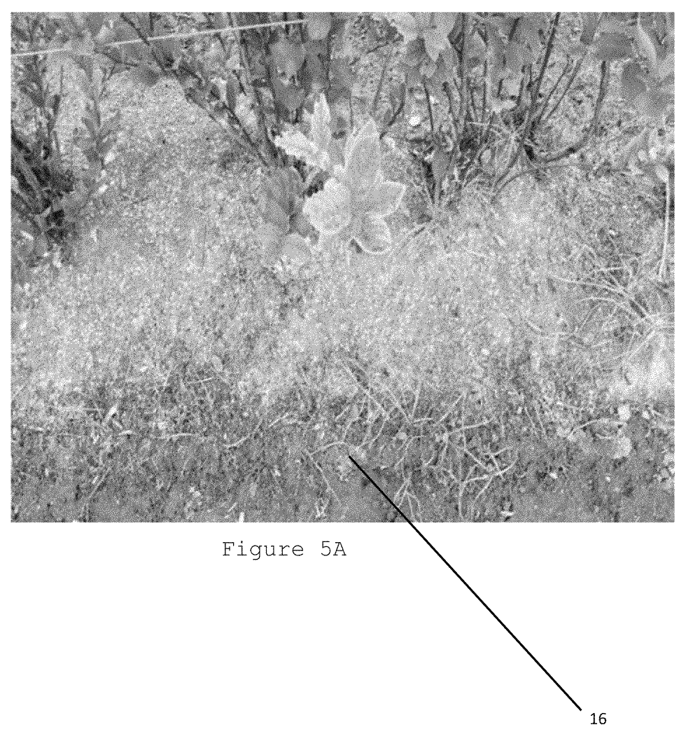

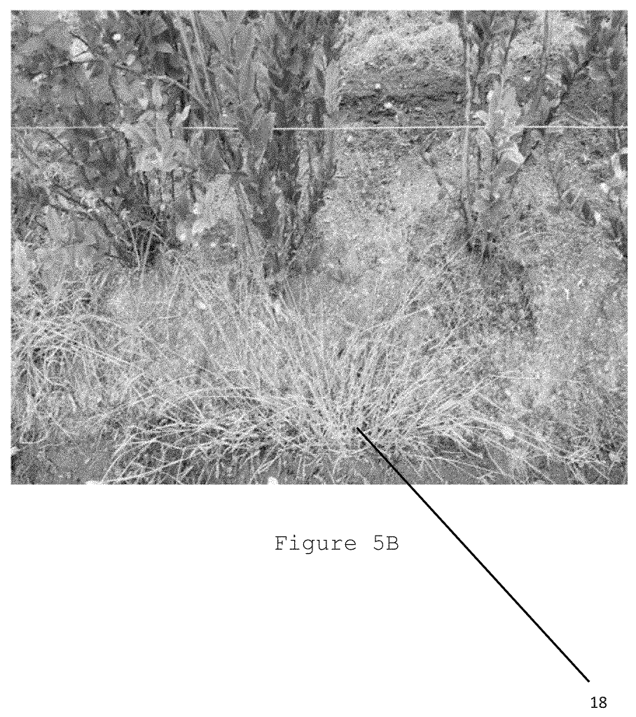

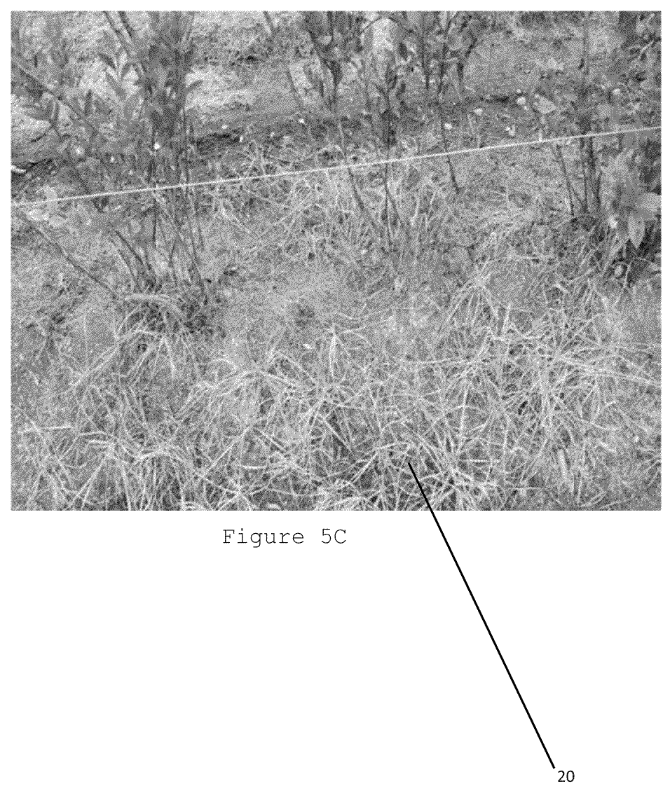

FIGS. 1-4 illustrate examples of plant species 10A, FIGS. 1, and 12A, FIG. 3, prior to application of the herbicide composition in accordance to the present invention, and after application, 10B, FIGS. 2, and 12B, FIG. 4. As illustrated, after application, the plant species have lost their green coloration and have been killed off, including the root system. FIGS. 5A-5C illustrate the effect of herbicide composition on various plant species, Nutsedge (FIG. 5A), Purslane (FIG. 5B) and Crabgrass (FIG. 5C), 2 weeks after application of the herbicide composition.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention, and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A composition for the prevention or minimization of growth and development of one or more plant species comprising:
a plurality of microbial species for preventing or minimizing growth of said one or more plant species; and
a microbial species growth or replication enhancer.

2. The composition for the prevention or minimization of growth and development of one or more plant species according to claim 1, wherein each of said microbial species are independent bacterial species.

3. The composition for the prevention or minimization of growth and development of one or more plant species according to claim 2, wherein said plurality of microbial species for preventing or minimizing growth of said one or more plant species includes a Streptomyces species.

4. The composition for the prevention or minimization of growth and development of one or more plant species according to claim 3, wherein said Streptomyces species is Streptomyces rimosus.

5. The composition for the prevention or minimization of growth and development of one or more plant species according to claim 3, wherein said plurality of microbial species for preventing or minimizing growth of said one or more plant species includes a Bacillus species.

6. The composition for the prevention or minimization of growth and development of one or more plant species according to claim 5, wherein said Bacillus species is Bacillus megaterium.

7. The composition for the prevention or minimization of growth and development of one or more plant species according to claim 5, wherein said plurality of microbial species for preventing or minimizing growth of said one or more plant species includes a Pseudomonas species.

8. The composition for the prevention or minimization of growth and development of one or more plant species according to claim 7, wherein said Pseudomonas species is Pseudomonas aeruginosa.

9. The composition for the prevention or minimization of growth and development of one or more plant species according to claim 1, wherein said microbial species growth or replication enhancer comprises Eugenol.

10. The composition for the prevention or minimization of growth and development of one or more plant species according to claim 7, wherein said microbial species growth or replication enhancer comprises Eugenol.

11. The composition for the prevention or minimization of growth and development of one or more plant species according to claim 10, wherein said microbial species growth or replication enhancer comprises a sugar.

12. The composition for the prevention or minimization of growth and development of one or more plant species according to claim 11, wherein said sugar is molasses.

13. The composition for the prevention or minimization of growth and development of one or more plant species according to claim 7, wherein said bacterial strain of Streptomyces, Bacillus, or Pseudomonas are at a cell density of at least 5.0×10³ CFU/ml.

14. The composition for the prevention or minimization of growth and development of one or more plant species according to claim 10, wherein said bacterial strain of Streptomyces, Bacillus, or Pseudomonas are at a cell density of at least 5.0×10³ CFU/ml.

15. The composition for the prevention or minimization of growth and development of one or more plant species according to claim 1, wherein said plurality of microbial species for preventing or minimizing growth of said one or more plant species or said microbial species growth or replication enhancer component is in a liquid form or a soluble, dry powder form.

16. A composition for application to one or more plant species comprising:
at least three bacteria species for preventing or minimizing growth of said one or more plant species, wherein at least one bacteria species produces a biosurfactant, and a bacterial species growth or replication enhancer.

17. The composition for application to one or more plant species according to claim 16, wherein said composition is formulated as a two-part component, wherein said at least three bacteria species are separated from said bacterial species growth or replication enhancer.

18. The composition for the prevention or minimization of growth and development of one or more plant species according to claim 16, wherein said at least three bacteria species include Streptomyces, Bacillus, and Pseudomonas.

19. The composition for the prevention or minimization of growth and development of one or more plant species according to claim 18, wherein said Streptomyces, Bacillus, or Pseudomonas are at a cell density of at least 5.0×10³ CFU/ml.

20. The composition for application to one or more plant species according to claim 16, wherein said bacterial species growth or replication enhancer includes an essential oil extract and a sugar.

21. The composition for application to one or more plant species according to claim 16, wherein said sugar is molasses.

22. The composition for application to one or more plant species according to claim 16, wherein said essential oil is Eugenol.

23. The composition for application to one or more plant species according to claim 16, wherein said at least three bacteria species component or said bacterial species growth or replication enhancer component is in a liquid form or a soluble, dry powder form.

24. A method of preventing or minimizing growth and development of one or more plant species comprising:
applying an effective amount of a composition to a plant or plant component to minimize or prevent plant growth and development of one or more plant species, said composition comprising a plurality of microbial species for preventing or minimizing growth of said one or more plant species; and a microbial species growth or replication enhancer.

25. The method of preventing or minimizing growth and development of one or more plant species according to claim 24, wherein said composition is formulated as a two-part component, wherein said plurality of microbial species component is separated from said microbial species growth or replication enhancer until application to said plant or plant component.

26. The method of preventing or minimizing growth and development of one or more plant species according to claim 24, wherein said microbial species growth or replication enhancer comprises a mixture of Eugenol at 6% and a molasses/water mixture at 94%.

27. The method of preventing or minimizing growth and development of one or more plant species according to claim 24, wherein said composition is applied to any portion of said plant or plant component.

28. The method of preventing or minimizing growth and development of one or more plant species according to claim 24, wherein said composition is applied to a root system of said plant or plant component.
